(19) United States
(12) Patent Application Publication
(10) Pub. No.: US 2006/0179325 A1
(43) Pub. Date: Aug. 10, 2006

(54) Secure computer data storage method and device

(76) Inventor: Jacques Debiez, Cugnaux (FR)

Correspondence Address: YOUNG & THOMPSON, 745 SOUTH 23RD STREET, 2ND FLOOR, ARLINGTON, VA, 22202, US

(21) Appl. No.: 10/548,459

(22) PCT Filed: Mar. 12, 2004
(86) PCT No.: PCT/FR04/00601

§ 371 Date: Sep. 12, 2005

(30) Foreign Application Priority Data
Mar. 12, 2003 (FR) 03/03036

(51) Int. Cl. G06F 12/14

(52) U.S. Cl. 713/193

(57) ABSTRACT

A secure, tamper- and forgery-proof peripheral for the storage of authenticated, dated computer data with an evidential value. The invention is based on an optionally-rewritable, fully-integrated storage peripheral which is functionally protected by an electronic system which only authorizes the addition of data in the unused free space and prohibits the deletion, alteration or overwriting of pre-recorded data. At the end of each file-write operation, the date, which is provided by a non-modifiable internal clock that is calibrated only at the time of production, is associated therewith. Each device includes a unique integrated secret internal digital identifier which is associated with a unique public identifier and the identifiers are used to personalize the device and render same unreproducible. The association can be verified using several third methods which never divulge the secret internal identifier.

The present invention relates to methods and devices for secure, forgery-proof storage of computer data with the aim of ensuring the authenticity of the recorded data at a given date and also to associated processes and methods of production, verification, authentication and use.

Traditionally, such systems are implemented on single-write storage devices which are based on the ability of the medium used to be physically altered in an irreversible manner. These media (fixed or generally removable) are easy to reproduce in full. By way of example, very common non-rewriteable discs of the CDR and DVDR type are not, generally, individually identified and can therefore be manipulated on an external system and be recopied integrally after forgery on an identical blank medium. Similarly it is possible to corrupt the recording of a single-write medium by forcing rewriting over tracks already comprising data, the reader-writer offering none or little protection against native access commands being sent to the medium. Unique identification of the medium often comes into conflict with the ability to reproduce or forge and because the medium is not self-powered. Therefore overall it presents only a very low level of security. Magnetic media are more dense and of higher performance but are natively multiple-write, therefore even easier to corrupt.

One of the ways of compensating for the weaknesses of removable or rewriteable media is the use of cryptographic methods which effectively allow, at the moment of writing, authentication of the data but which increase the vulnerability to unique errors and often makes data sharing between users tedious. These often complex algorithmic methods do not however directly protect the medium and/or the reader, remain costly in calculation resources and are subject to obsolescence in the course of time. If they prove to be effective and necessary in the transactional domain in real time, they present numerous disadvantages as soon as either it is desired to use a large quantity of data or sharing of the data between a plurality of users is necessary or the data must be kept for several years. Access to the medium makes any cryptographic method null and void in any case, the medium being able to be duplicated and forged a posteriori.

The dating problem adds to the former, systems which date the files often displaying great vulnerability, and rarely preventing voluntary or involuntary corruption of the dates of the computer files. The structure of the file systems currently used is known and the associated dating is very rarely protected or encrypted, therefore vulnerable.

The ultimate solution resides in using third bodies which store the data, possibly encrypted, redundantly and ensure their physical protection. These methods can prove to be effective but are often logistically expensive according to the quantity of data to be transmitted. They use communication links which may be unavailable and/or poorly protected public networks. Other similar solutions for authenticating data involve digital signature methods, the third body only keeping the signatures of the files. The authenticity can be established by comparison of signatures. This does not prevent problems connected to the possibility that the original data are voluntarily or involuntarily corrupted at the time or that the development of computers allows forgery thereof. Likewise, the use of such methods makes recourse to signature software necessary—itself vulnerable.

Each method cited covers a particular field of application and offers no simple solution for recording with any autonomy internal, confidential, private or strategic data about an individual, a professional or an enterprise as soon as the quantity of data becomes large and must be able to be possibly presented or requisitioned as a posteriori authentic juridical and legal evidence.

The physical or legal entity who owns them, manages them or is responsible for them and does not necessarily have the wish or the technical and/or organisational means to transmit these data via—or to—an external third party because of their strategic, confidential or private nature.

The authorised or institutional bodies which, within the control or search framework, can request presentation of the data have no longer the means of copying, authenticating or guaranteeing the data from all users and are constrained to leave the care and control of the data to those transmitting them.

The totality of vulnerabilities means that it is extremely difficult to give a legal value to private computer recordings based on standard elements, and that in a contradictory manner, it appears to be more and more necessary to ensure the authenticity of data whatever they are, computer storage generally constituting the modern means of retaining information.

The method and the device according to the present invention seek to compensate for the ease of reproduction and forgery of paper, audio, video and standard computer recordings, and the mastery of which is entirely ensured by the persons who store and control the information, and who can therefore forge it or shorten it, backdate it a posteriori or be victims of internal or external attack on these data. The fact that this information is private can make the cross-checking of certain unique items of information impossible, lengthy or tedious. More precisely, the invention comprises a method for storing computer data, characterised in that it comprises integrating entirely in one device:
a data storage peripheral,
an adapted input-output controller transforming said data storage peripheral into a single- or restricted-write storage peripheral by diverting all input-output interface commands from a host system to the internal interface of the integrated data storage peripheral, in order:
to authorise exclusively the addition of new files in the free space by dating them independently thanks to a secure internal real time clock, and
to prohibit the deletion, alteration and rewriting of previously written and hence prior dated data,
to protect the totality of said device on the one hand against forgery or duplication by a unique secret internal identifier by association with a unique public serial number, on the other hand by a peripheral protection enclosure intended to prevent intrusion into the equipment, the alteration of any component and internal data, and also the analysis of the unique secret identifier without compromising the validity and authenticity in an irremediable manner,
to detect an intrusion, alteration and analysis attempt, said detections being able to be verified by several third party methods on said process, the latter being thus secure and suitable for storing authenticated, dated computer data with an evidential value.

According to an advantageous feature, the method according to the invention comprises furthermore reproducing electronically and internally said unique public serial number in order to allow electronic control of the latter.

According to an advantageous feature, the method according to the invention comprises furthermore physically protecting all the internal components by leaving accessible only the external functional input-output and supply interfaces, thanks to a peripheral sealed enclosure encompassing all the components, formed by a passive mechanical and electromagnetic protection incorporating an active intrusion detection sensor and the associated electronic system, the latter ensuring the immediate destruction of the unique secret internal identifier and the internal serial number if necessary, by instantaneous deletion, in the case of voluntary or involuntary impairment changing the vulnerability or the autonomy of the device, or any internal investigation attempt detected by the sensor being able to make it possible to compromise, control, alter, analyse data, interfaces or internal components.

According to an advantageous feature, the method according to the invention comprises furthermore keeping active the internal real time clock, the secret identifier, the internal serial number if necessary and the electronic system for detection of intrusion and destruction, without any external supply source for the lifespan specified for the equipment, thanks to an autonomous internal supply sub-system, possibly backed-up externally in order to extend the lifespan thereof.

According to an advantageous feature, the method according to the invention comprises furthermore making it possible to guarantee the unique, unreproducible personalisation of the equipment whilst publishing its existence, possibly before authentication, by generating randomly by calculation internally of the equipment, the unique secret identifier, by calculating internally a one-way digital fingerprint of this identifier which does not allow return to the latter, by establishing the uniqueness of the fingerprint by interrogation of a public database containing the fingerprints of the totality of existing equipment, the identifier being recalculated if there is a clash and the device being formally identified as soon as the fingerprint is unique, by adding therefore into the public database the references of the equipment: unique serial number and fingerprint.

According to an advantageous feature, the method according to the invention comprises furthermore ensuring the authenticity of the device after manufacture, the test, the final assembly and the activation of the peripheral protection, until acquisition by the end user, by making unique the operations for assigning the unique serial number, the synchronisation of the real time clock relative to an external trusted time reference, internal self-generation of the unique secret identifier, the external copy of the unique secret identifier in a secure environment of the unique secret identifier to an authenticating body entitled to guarantee the secrecy of this identifier and in fact the authenticity of the equipment, the uniqueness of each operation being guaranteed by design by inhibiting or destroying, in an irreversible manner and as soon as possible in the initialisation sequence, the material elements and/or the micro-code allowing this initialisation.

According to an advantageous feature, the method according to the invention comprises furthermore allowing without limitation on the occurrence, the preliminary verification of the authenticity and of the integrity, by checking and cross-checking unique listed serial numbers in the public database, by checking the validity and the progress of the internal clock relative to an external trusted time reference, taking into account the maximum specified drift of the internal clock, and by visual or non-destructive checking of the integrity of the external casing.

According to an advantageous feature, the method according to the invention comprises furthermore allowing authorised bodies to authenticate the equipment upon request by verification via third party methods using the secret internal identifier without revealing it, by internally recalculating dynamically the fingerprint of the identifier and by directly interrogating the public database, or by internally connecting the secret identifier to the internal date and to an external message provided before internal calculation of the fingerprint of the totality, the totality of known elements being provided for authentication remotely by the entitled authenticating body which alone can verify the consistency thanks to the copy of the unique secret identifier which it has, these functions involving the secret identifier being temporised and limited in occurrence internally of the equipment in order to avoid inverse determination of the identifier by analysis or successive attempts.

According to an advantageous feature, the method according to the invention comprises furthermore allowing the authenticating body itself to authenticate the equipment under its control and as a last resort by injecting its copy of the secret identifier for comparison internally of the equipment which detects perfect similarity, and sends in reply a unique message which can be verified by said authenticating body, this function involving the secret identifier being temporised and limited in occurrence internally of the equipment in order to avoid inverse determination of the identifier by analysis or successive attempts.

According to an advantageous feature, the method according to the invention comprises furthermore allowing, by way of variant which is not necessarily implemented, managing autonomously the expiry of data in the past, by authorising—solely in the case of complete filling of the internal storage peripheral—writing of new files by zapping, within sufficient limits and in chronological order, data prior to a relative date, updated dynamically relative to the current date provided by the internal clock, departing thus from the single-write rule without however compromising or altering the useful data which are still valid and dated subsequently to the expiry date.

According to an advantageous feature, the method according to the invention comprises furthermore presenting any internal parameter and indicator which is characteristic of and specific to said device in the form of virtual files in reserved names, seen by the host system as standard files and avoiding using drivers or particular operating modes at the level of the host system for management, administration and monitoring of said device.

According to an advantageous feature, the method according to the invention comprises furthermore partitioning said data storage peripheral with a different expiry duration by partitioning.

The present invention relates furthermore to a device for storing computer data, characterised in that it integrates in full:
a data storage peripheral comprising an internal interface,
an adapted input-output controller,
an input-output interface,
a secure internal real time clock,
a unique secret internal identifier,
a unique public serial number,
a peripheral protection enclosure,
   said adapted input-output controller being able to transform said data storage peripheral into a single- or restricted-write storage peripheral by diverting all input-output interface commands from a host system to the internal interface of the integrated peripheral, in order:
to authorise exclusively the addition of new files in the free space by dating them independently thanks to the secure internal real time clock, and
to prohibit the deletion, alteration and rewriting of previously written and hence prior dated data,
   the totality of said device being protected on the one hand against forgery or duplication by the unique secret internal identifier by association with the unique public serial number, on the other hand by the peripheral protection enclosure preventing intrusion into the equipment, the alteration of any component and internal data, and also the analysis of the unique secret identifier without compromising the validity and authenticity in an irremediable manner, intrusion, alteration and analysis attempts being able to be verified by several third party means on the totality of said device, the latter being thus secure, inviolable and forgery-proof, suitable for storing authenticated, dated computer data with an evidential value.

The device according to the present invention is integrally protected against rewriting and able to give an authentic, evidential and/or legal and/or juridical value to the digital data. The data are recorded in an irreversible and dated manner with sufficient precision in an entirely autonomous manner. The device is self-protected and identified in a unique manner. Any attempt to alter or compromise the device results in its invalidation. Identical duplication of the device is made reasonably impossible.

Use of the device allows, without specific constraint and without using a third party during its use, any person anxious to be able to establish his good faith and the legality of his activity, to do this by leaving him free will over the data which he wishes or must thus protect. The device does not in any case prevent dissimulation, complete destruction of data, of information or evidence nor possible a priori forgery in all cases, but establishes a posteriori that the data, when they are presented, have indeed been recorded at the indicated date, and have not been able to be forged or replaced subsequently.

The originality of the device is that its operating principle is independent of any clumsy cryptographic method, which is subject to obsolescence or expiry due to unforeseeable progress in crypto-analysis. Cryptography is not necessary in the sense where the user controls and physically possesses the device, and must decide upon the degree of confidentiality and protection of the data independently of the physical storage peripheral which he is using. It minimises the intervention of third parties for authentication of the data, allows the transmission of strategic or critical information on third party networks at a distance to be avoided, and in fact allows more data to be protected, or transmission of paper or microfilm data to a computer medium which is easier to use and to archive.

The importance of the described device is the possibility of using as a physical storage element any rewritable or non-random access data peripheral without impairing the performance, reliability or environmental resistance and giving it a neutral transparent behaviour relative to the host system, thus leaving the end user the freedom to use the external software compression methods, cryptographic protection and reliable storage put at his disposal.

The device which is the subject of the invention includes the constituent peripheral equipment (termed subsequently equipment), but likewise the methods and processes which permit manufacture and verification of the equipment by third parties, and the description of certain particular modes of operation.

The device integrates in full a standard commercial data storage peripheral with a removable medium or one made removable (by way of non-limiting example: a magnetic technology hard disk, a flash memory disk, a CD/DVD writer, the ejection mechanism of which is de-activated, loaded with a writable medium), the interface of which is protected and isolated by a specific controller, limiting by design the storage operations to the single function of adding data. The equipment is seen a priori by a host computer system as peripheral computer storage equipment, except that it is functionally impossible to alter, delete or to rewrite previously written logic recordings. It is only possible to read them. A dating clock calibrated during manufacture, which is non-alterable and autonomous, dates any recorded file in real time and independently of the host system. Dating of the files is recorded by the electronic control system on the internal peripheral, either in addition to the recording of the user data with a reference to the basic descriptor of the logic or file recording with which it is associated as metadata, or in the descriptor itself of the file in place of dating information normally provided by the host system, or in the unused or non-specified spaces of this file descriptor. The totality of this dating information is accessible in read only to the host system which allows verification of the dating authenticated by the device for each written recording.

The equipment behaves overall like a single-write type peripheral which re-dates the information relative to a relative reference time which is sufficiently precise, and the drift of which can be measured, and even authenticated. The integrated peripheral is therefore only filled as if it included a physically non-rewriteable medium.

By way of a variant which is not necessarily implemented and under very restrictive conditions, the equipment can easily administer an expiry date in the past relative to its internal clock, therefore at its own dating which possibly allows the space occupied by obsolete data to be freed in order to write new recordings when the peripheral is ‘full’. This functionality termed ‘expiry’ makes it possible to fulfil the specific data storage needs for a short lifespan before the overall lifespan of the equipment which presents an interest in certain application fields.

An autonomous identification electronic sub-system contains the authentication elements of the equipment which are unique and kept secret and prevents duplication or production of false equipment from new parts or those recovered from voluntarily compromised equipment. The unique internal identification elements are systematically destroyed during non-authorised physical access attempts. An active peripheral protection enclosure integrally protects the totality physically and detects any penetration or intrusion or investigation attempt with the aim of compromising the integrity of the equipment, of accessing internal interfaces which make it possible to alter the data and to extract the identifiers therefrom. In the case of an intrusion attempt, the equipment instantaneously and in an irreversible manner destroys the unique identification elements and possibly the clock. The equipment is invalidated and is returned into an initial mode which continues to protect the written data on the storage peripheral without destruction of the equipment, by invalidating any writing operation. The data remain readable in all circumstances.

Any equipment, the integrity of which can be confirmed by non-destructive analysis methods which are available (essentially the verification of the unique identification elements), ensures the validity and authenticity of data read on the internal peripheral.

In the case of doubt or suspicion, the entitled authenticating body having, itself alone, a copy of the secret identifier, can submit the copy of the secret identifier which it has to the equipment which itself effects the internal comparison or allows a third authorised party to verify indirectly this identifier while limiting the request intervals in order to avoid its determination by, by way of non-limiting example, using a brute force or screening or targeted analysis method.

In the case of a critical internal crash, the voluntary dismantling of the equipment can be effected in order to make an assessment of it or to effect the recovery of the data following the manufacturer's instructions. With this aim, a procedure must be able to allow simple cut-out of the equipment which has the effect of instantaneous invalidation of the authenticity, then the extraction without impairment of the internal storage peripheral, but allows access directly to the latter, to the data which is a priori non-encrypted by the equipment and possibly to the medium.

Any damaged or corrupted equipment loses its authentic value: the present data are no longer guaranteed any more than if they had been stored on any non-secure medium, in contrast they remain accessible at least for reading as long as the equipment is functional.

As with any security method, the probability of non-detection of intrusion or the possibility of duplication of the equipment is made negligible but not nil and is reduced to the reasonable minimum as a function of the intended objective cost and the required level of protection.

The present invention includes the methods and the sequencing of operations subsequent to the material manufacture of the equipment, which ensure in an irreversible manner after sealing of the protective casing of the equipment:
sure and incorruptible dating,
unique secret identification,
   whilst making independent the manufacturer of the equipment, the entitled authenticating body (by way of example one for each nation, consortium, community) and the end user.

The present invention includes several processes or methods for verification associated with the formal authentication of the equipment according to the invention. These processes or methods for verifying the authenticity use or do not use external third parties, and/or use or do not use the secret internal identification.

Other features and advantages will appear in the text which follows of several examples of embodiments of methods and devices according to the invention, accompanied by the annexed drawings, examples which are given by way of illustration and non-limiting.

According to a particular embodiment, the device is administered and configured using a method of virtual files, seen by the host system as standard files present on the integrated peripheral. This method presents any parameter and internal indicator which is characteristic and specific to the described device in the form of reserved name files accessible in a standard manner by the host system, avoiding the use of drivers or particular operating modes at the level of the host system for management, administration and monitoring of the device and described variants and options.

FIG. 1 represents an overall operating diagram of the equipment,

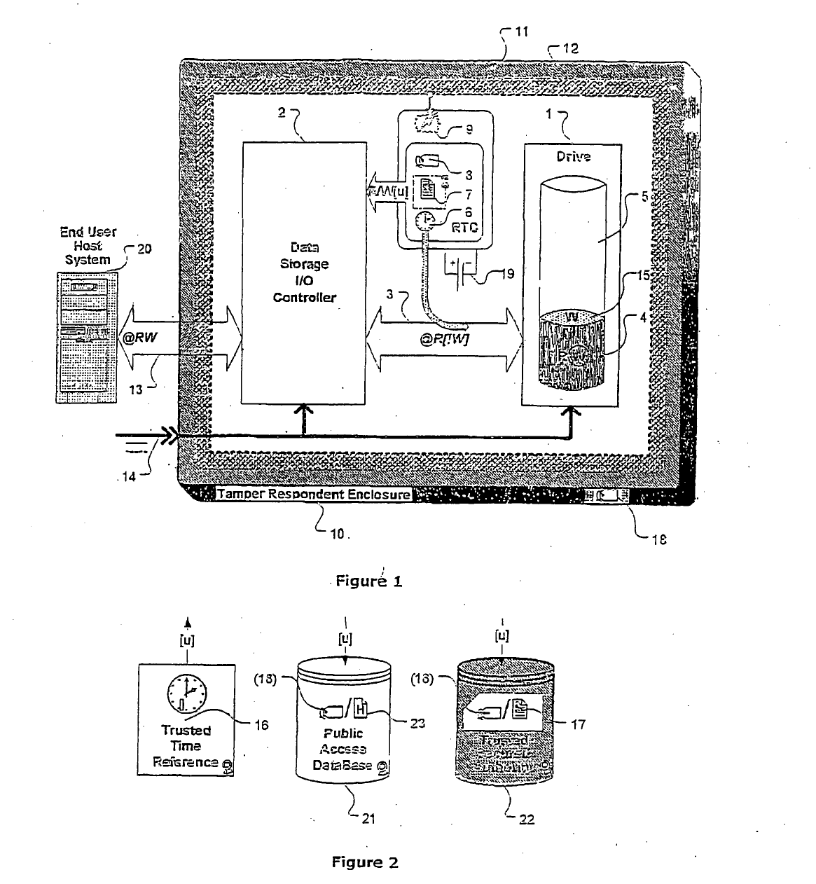

FIG. 2 illustrates the role of external third parties,

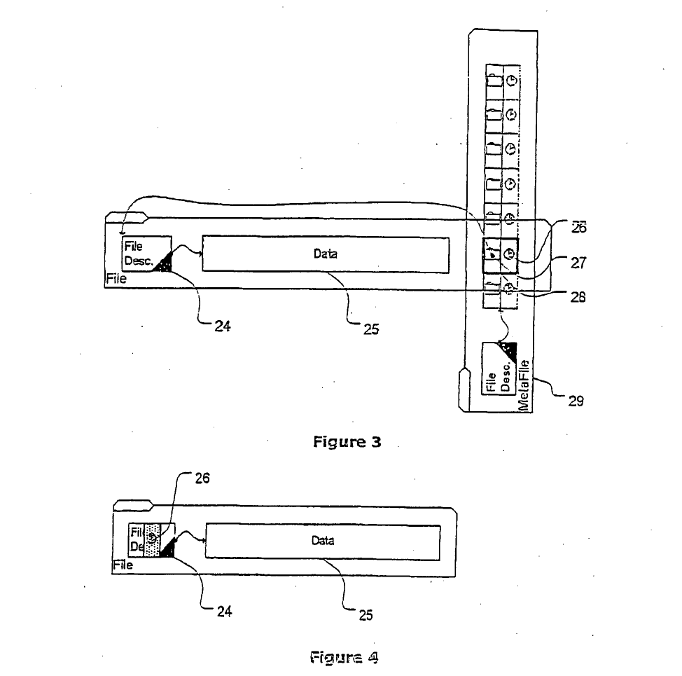

FIG. 3 illustrates a suggestion for file structures with dating by adding metadata,

FIG. 4 illustrates a suggestion for file structures with dating by replacement in the file descriptor,

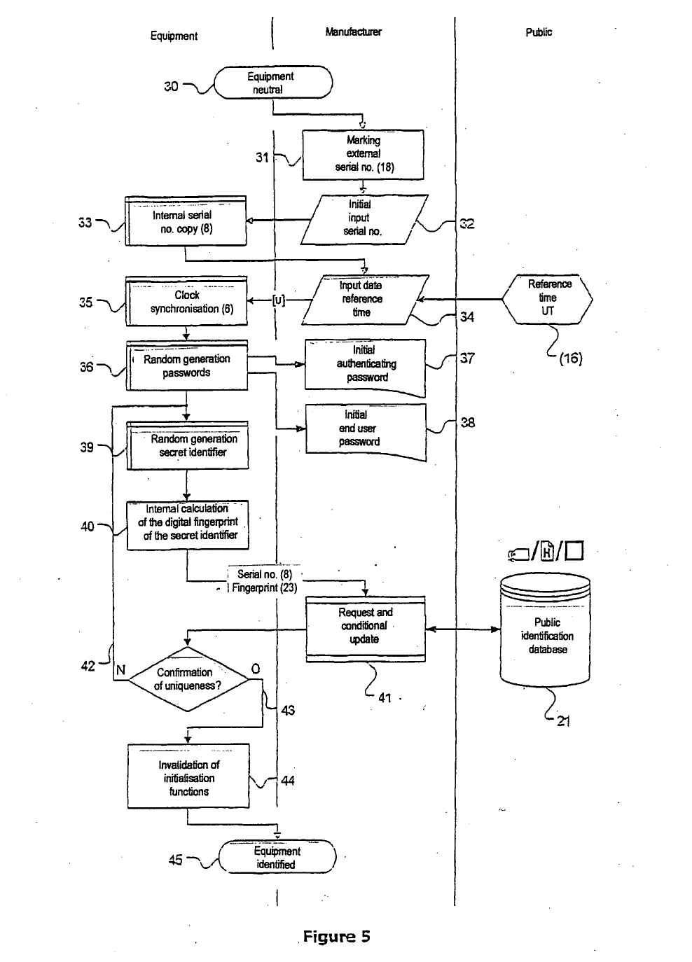

FIG. 5 illustrates the secure initialisation and identification process of each piece of equipment individually by the manufacturer,

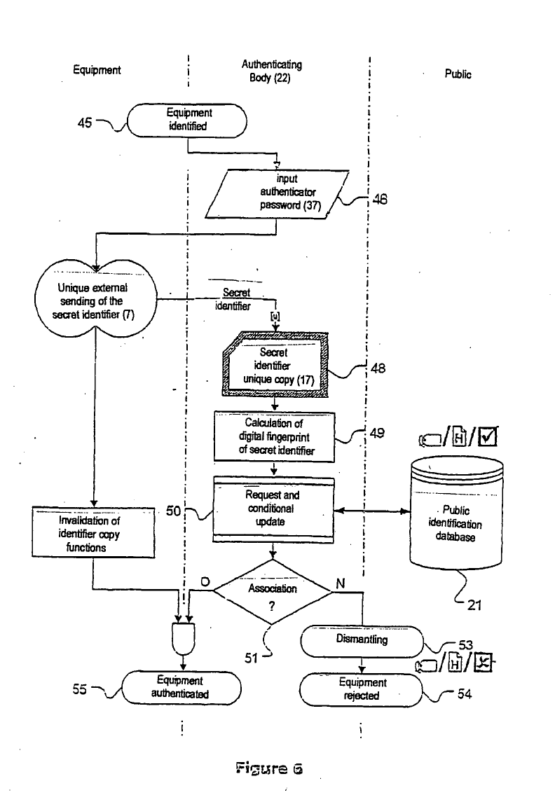

FIG. 6 illustrates the secure process of authentication of each piece of equipment,

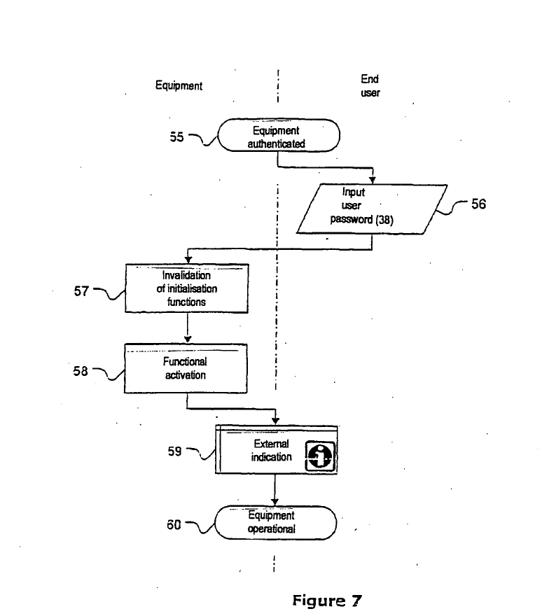

FIG. 7 illustrates the secure process for activation by the end user,

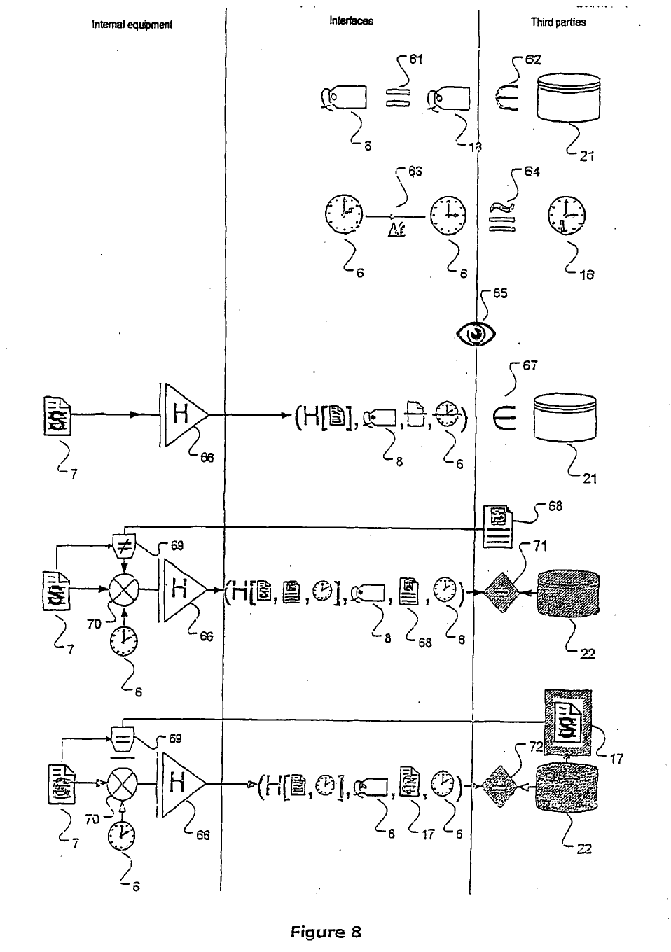

FIG. 8 illustrates the various authentication methods and processes connected with production of the described device.

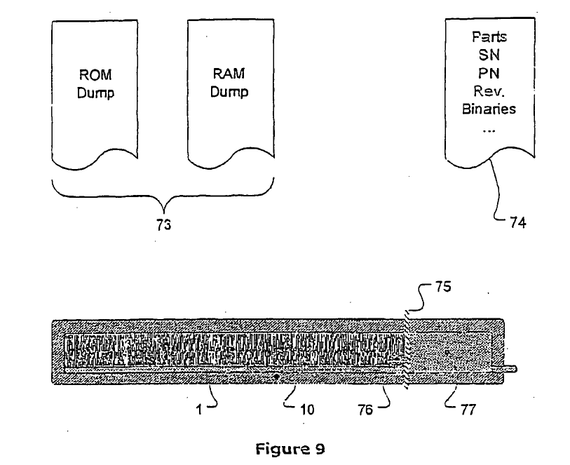

FIG. 9 illustrates the various assessment methods of the equipment,

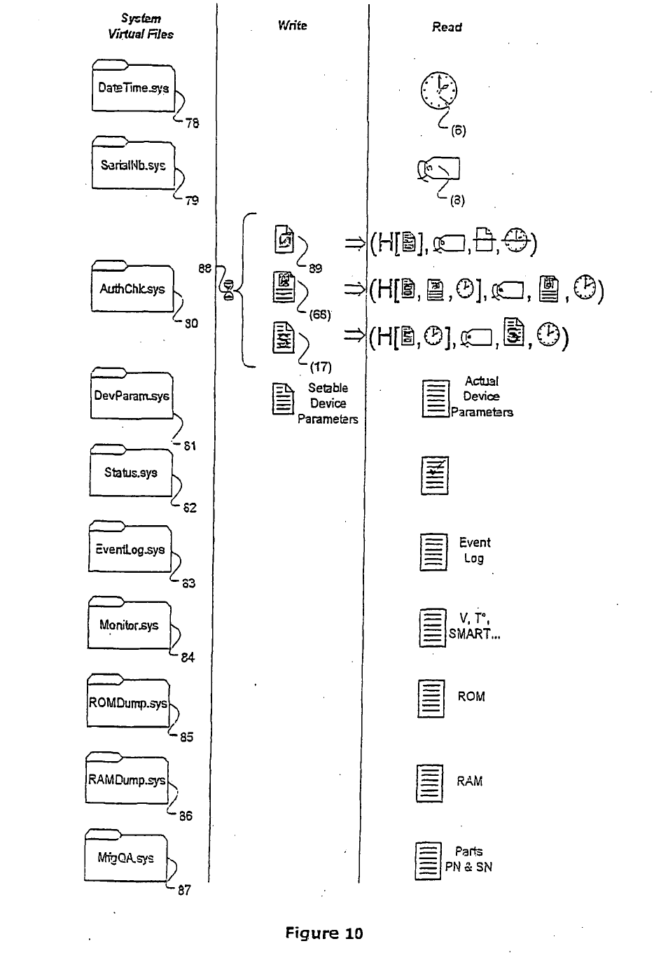

FIG. 10 illustrates the suggestion for using virtual files in order to administer the equipment,

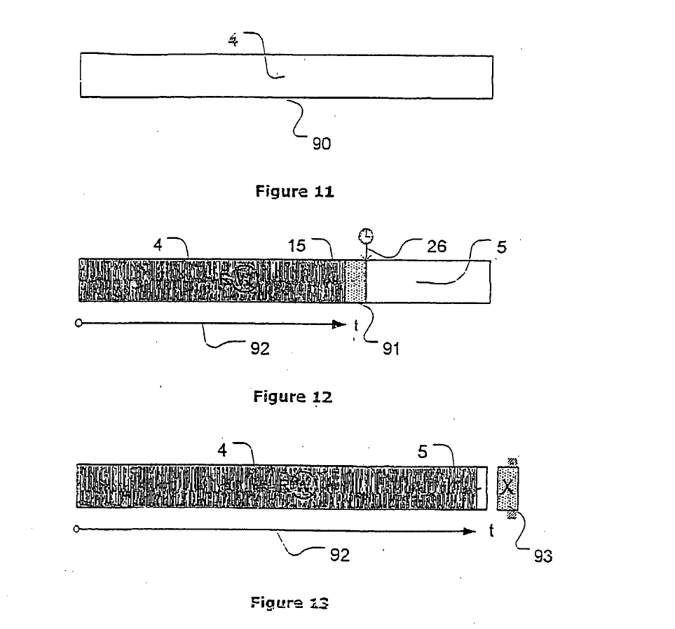

FIGS. 11 to 13 illustrate the filling of the medium,

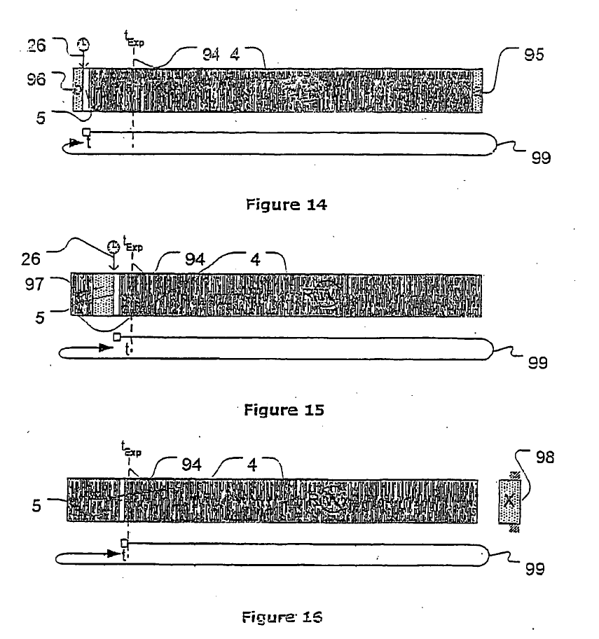

FIGS. 14 to 16 illustrate the filling of the medium with positioning of the expiry mechanism,

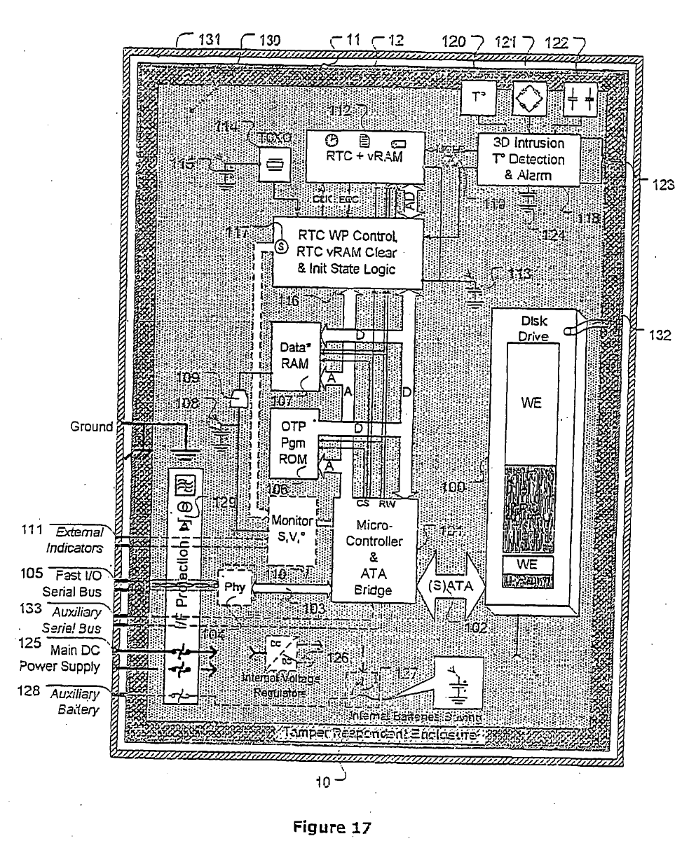

FIG. 17 represents a detailed diagram for a production suggestion.

The sign [u] on certain Figures signifies that the action is functionally unique and irreversible. Certain signs are intentionally worded in English in order to conform with usage of the technology.

The device which is the subject of the invention integrates one or an assembly of standard peripherals for storing computer data 1. This peripheral is isolated from the host system by a controller 2 which limits the operation to adding data and ensures independent dating of the stored data thanks to an internal clock 6. The device comprises a pair of unique electronic digital identifiers 7, 8 which prevent duplication of the equipment. The assembly is protected by an active tamper respondent enclosure 10 which destroys the unique secret identification elements in the case of an attempt at tampering. The device is then invalidated and loses its authenticity.

The integrated peripheral 1 is a read-write model, no prerequisite being necessary concerning the possibility or not of deleting or re-writing the data (by way of non-limiting example a magnetic hard disk, a flash disk).

Generally, such peripherals address physical storage elements termed communally blocks, which are classically numbered in sequence, and logic storage elements of a higher level which can be manipulated by a system or host computer termed communally files, directories. All these entities are often accessible sequentially or randomly in read and in write. A storage peripheral normally has no knowledge of the logic level, managed entirely by the host system via a system of files (File System) subject to strict and easily analysable specifications.

With the aim of simplifying the language, we will term blocks the physical entities addressable by the peripheral and files the logic entities manipulated by the host system, without detailing the concepts of recording, clusters, directories and associated attributes.

The functional interface 3 of the integrated storage peripheral 1 allows a priori any operation: classically, addressing, writing and reading of blocks, and uses a priori no protection nor limitation on these functions. This interface is isolated functionally by an active intelligent controller 2 with an external interface 13 emulating a data storage peripheral of a substantially lesser capacity than the capacity of the real system. The physical input/output interfaces 13 and 3 do not necessarily have to be identical, just as the peripheral recognised by the host system 20 does not have to be identical to the peripheral 1 which is actually integrated, even if, in practice, the similarity on this precise point can simplify the overall functioning.

When it is supplied externally with electricity 14, the equipment is in its nominal operating mode. The controller 2 translates in real time any addressing, reading and writing request from the external interface 13 to the internal interface 3. The data themselves are not processed, nor compressed nor encrypted and are stored as such if authorisation to write them on the integrated peripheral 1 is validated by the controller 2 which has a basic knowledge of the logic storage level, therefore of the structure of the files and directories.

In its nominal operating mode, the controller protects the data against re-writing thus emulating a storage system ‘with addition only’: At the end of manufacture, the equipment is devoid of user data and pre-formatted therefore able to receive data. Overall, it therefore maintains a partition between the ‘occupied’ space 4 and the ‘free’ space 5. By way of non-limiting example of implementation, it maintains a ‘pointer’ 15 which indicates from which block of data the writing of new blocks is possible and overall inhibits any writing to the preceding blocks. In actual implementation, the partitioning can be more complex as a function of the system of logic files used, which itself can impose specific partitioning between physical and logic information, as represented in FIG. 17, being able to necessitate the simultaneous management of several pointers. Access to the physical memory is therefore random in read in the occupied space 4, and purely sequential in write in the free space 5. An attempt to delete, alter or re-write a file or previously written data results therefore in an error reported to the host system 20, thus signalling the impossibility of effecting the desired operation on the emulated peripheral. Writing new data, new files or creating new directories is possible, the storage peripheral is therefore filled inexorably up to its maximum useful capacity and rejects the writing of files which exceed the remaining size. It is therefore ‘full’ and must be completed or replaced by identical equipment since it is operationally impossible to delete the written files. It can then be disconnected and physically archived without any supply 14 external to the apparatus during the storage duration of the latter, an internal supply sub-system via batteries 19 making possible maintenance of critical internal elements (clock, identifiers, pointers . . . ) purely by way of indication, between ten years and twenty years according to the lifespan of the internal elements which are subject to ageing or are perishable, such as the batteries. Storing for longer durations can dictate either the use of auxiliary external batteries, taking the place of internal batteries, or certified transmission of these data with their date of creation to new equipment.

The written data are protected against any electronic attack (virus, malice, forgery . . . ) since they cannot be rewritten or altered by design. The destruction of data implies destruction of the equipment.

The controller 2 is specifically adapted to the structure of a standard file system (by way of non-limiting example, FAT, NTFS, UDF, NFS, HFS, sequential . . . ), or to the structure of a proprietary file system in the case where the equipment is to ensure compatibility with a plurality of different standard file systems. The file system creates the link between logic storage and physical data storage. The controller 2 detects by analysis sent write orders, the end of a logic storage operation (by way of example, the end of writing a file, or the creation of a directory entry). The sequential nature of writing data, without the possibility of deletion, greatly simplifies this task.

At the end of a successful logic writing operation, the controller effects the following tasks in an autonomous manner:
irreversible protection of the storage elements used for the file descriptor 24, and for the data themselves 25, by reservation of used blocks, for example tabulation and/or pointing 15 into a safeguarded memory which is accessible to the controller, and by redundancy over a reserved space on the storage peripheral itself.
independent dating 26, thanks to the internal reference dating clock 6, either by writing supplementary blocks of masked metadata to the host computer 28, as represented in FIG. 3, or by rewriting this date in place of the date written by the file system in the file descriptor 24 as defined by the used file system, as represented in FIG. 4.

The written data are dated to the second in an autonomous manner relative to the internal clock 6 of the device, by the equipment itself, independently of the host file system which applies its own dating, often not so certainly and reliably. This internal dating is irreversible and forgery-proof, the internal clock being set to time once during manufacture and not being able materially to be reset timewise subsequently, and the recordings comprising these data being protected against rewriting. The precision of the dating is based entirely on the precision and the drift of this internal clock which can be correlated externally without however the possibility of correcting it. The dating is effected in universal time.

In the case where the device imposes the dating by adding metadata 28, the latter are made invisible in normal use of the files and are themselves protected against rewriting. The metadata are at least composed of a pointer 27 allowing access to the descriptor of the file or of the directory and a structure comprising the internal date and time 26 at the end of writing. The totality of metadata of the totality of written files is addressed in a ‘system’ file 29 which is accessible in read only. A tool or else the analysis of this file makes it possible to correlate the metadata and the user files and therefore to verify the internal date which the device had assigned to each file during recording which is only authentic by design.

In the case where the device imposes the dating of the files by replacement 26 of the date of creation in the descriptor 24 of the file, in conformity with the demands of the file system which is used, the behaviour of the device is perfectly standard. The date imposed by the equipment differs from the system date and can, in the case of a practical concern, be corrected dynamically internally at the moment of reading in order to take into account the difference between local time and universal time (time zone). Most file systems currently used manage a plurality of dates (by way of example the alteration date which is useless in our case), it is therefore possible also to keep the date of the external system as purely indicative.

The equipment is itself made forgery-proof thanks to a unique identification method implemented internally of the equipment. It is reasonably impossible to duplicate the equipment without the complete knowledge of the unique identification which is never divulged by the device, outwith an initialisation phase or solely an entitled authenticating body 22 receives the integral copy of this identifier, one part of which remains kept secret. The identification elements are destroyed as soon as an intrusion, tampering or compromising attempt on the equipment is detected. The identification is used only for validation and authentication of the equipment and has no operational role for the end user.

The identification system is composed of the following elements:
unique public identification element 8, 18: serial number of the entire equipment, marked visibly and indelibly on the equipment 18 and reproduced electronically internally 8 for reasons of facility of use and direct authentication.
unique secret identification element 7 generated and stored imperatively internally of the equipment and verifiable solely by third party methods which never distribute this identifier.
optionally manufacturer identification elements, not shown: by way of example, electronic or marked serial number of the internal components, date code, batch numbers, inspection numbers, often indicated by the manufacturer within the scope of its quality system, which depend upon use and which may allow verifications or supplementary reports possibly after dismantling of the equipment.

The association between the public identifier and the secret identifier is known solely by an entitled third party authenticating body 22 which is involved at the end of the manufacturing process. The secret identifier is distributed once and once only 17 outwith the equipment for the attention of this single body 22 which preserves the totality of the information relating to the totality of equipment which it manages and authenticates.

This body is the only third party which is involved in the authentication of each piece of equipment, solely initially at the end of manufacture of the equipment and possibly during use in the case of extensive inspection of the authenticity of the equipment if doubt persists about this authenticity or if the stakes or the legislator justifies such recourse.

The unique electronic identifiers of the equipment 7, 8 (except for manufacturer identification numbers which are not described because linked to the implementation and components used) are stored in a safeguarded volatile memory circuit by battery 19 and having a rapid internal and/or external delete function 9. The absence or inconsistency of one of these identifiers indicates the compromising of the equipment.

Only a one-way fingerprint 23 of the unique secret identifier associated with the serial number 18 of the equipment is distributed publicly 21 outwith the entitled authenticating body or bodies 22 which alone have access to the association between the serial number 18 and a copy 17 of the unique secret identifier.

The unique secret identifier is a long length binary message (by way of example 4096 bits or more), certain values being able to be reserved and not being able to be used.

The internal clock 6 is set at universal time once during manufacture of the product relative to an authenticated reference clock 16, and cannot be subsequently reset timewise by design without corruption of other integrity parameters of the system.

The system thus described has validity only if it is physically self-protected against tampering and internal analysis. To this end, the described assembly is integrally confined in a protective enclosure 10 by a peripheral sensor 12 which is sensitive to intrusion, supplied by a battery 19 having a long life span (by way of example, lithium battery). Any attempt at penetration and internal analysis by a microprobe is, on the one hand, made extremely difficult by external mechanical and electromagnetic protection 11 and, on the other hand, triggers an alarm in the case of penetration beyond a limit casing 12 which encompasses any functional component of the equipment. The alarm results in the instantaneous destruction 9 (deletion/resetting to zero) of the internal identifiers 7, 8, making the equipment non-replicable thanks to the inaccessible secret part 7 which cannot be analysed without penetrating into the equipment, therefore without triggering the alarm.

The equipment is integrally protected by an active physical enclosure which ensures protection against intrusion by any known method, standardised in certain countries for the protection of security-critical parameters and/or cryptographic modules (by way of example in the United States FIPS 140-2 standards or internationally standard ISO 15408/Common Criteria AVL). The use of such methods can be made very cheap by manufacturing in series, even for the highest levels of security. Such sensors exist commercially (by way of example the D³ sensors of Gore brand, FIPS 140 certified, level 4) and their general principal is described purely informatively for clarification, referring at times to FIG. 17. Classically, the peripheral protection 10 is composed of an external mechanical protection 11 or sealed external box (by way of example in metal which is machined, moulded, folded, assembled, so that it cannot be dismantled, by welding, crimping) leaving room solely for functional interfaces for communication and supply, and a sensitive sensor 12 detecting intrusion (piercing, machining, mechanical, electrical or laser, selective chemical attack) by altering an electrical parameter (resistor 121 and/or capacitor 122 and/or contact 123). Often, this sensor is produced on the basis of a network of conductors and insulators which are sensitive to cutting, breaks and short circuits, covering the entire enclosure to be protected in a uniform manner, and provided with ‘baffles’ in order to protect the external operating interfaces. The electronic alarm and detection system 118 is low consumption in order to be able to ensure great autonomy for the protection supplied in an autonomous manner by battery 124. Normally, the totality of the electronic system and of the internal components is sunk in a resin 130 which is intended to ensure the thermal conduction in the absence of internal convection and prohibiting direct access to the components or the internal signals. The aim of the protection system is to prevent the insertion of a micro-probe making it possible to analyse or control directly internal electrical interfaces which allow alteration of the protected data, analysis of the elements which are kept secret with a view to their duplication.

In order to eliminate any thermal attack, a temperature sensor 120 analyses excessively high or low temperatures which can inhibit or limit the effectiveness of the sensor.

The failure of the batteries 124 immediately places the system in a state of alert.

The protection likewise includes external electrical interfaces in excess voltage/excess current frequencies or signals outwith specification 129. In order to facilitate the protection, the operating interfaces are reduced to the minimum by the use of rapid series operating buses (by way of example reflecting the current state of technology FireWire/i-Link/IEEE1394, USB, Serial ATA, Ethernet), of a continuous external supply and static state interfaces of the system.

In the particular case of use of a hard magnetic disk which must operate under atmospheric pressure, the operating depressurisation capsule of the disk is carried externally thanks to an integrated tube allowing free passage of air without increasing the vulnerability of the external protection 132.

The intrusion detection in the enclosure results in the destruction of the integrity parameters 7, 8 of the equipment by instantaneous deletion 119, 9 of memories 112 safeguarded by internal battery 113, 19, this being the case whether the device is supplied externally or not. This destruction of the identification parameters of the system does not prevent access in read to the totality of the data. The controller 2 continues to protect the data, which lose their authentic value as soon as the equipment is reported to be compromised.

The equipment is designed to be autonomous in normal use. It does not therefore assume any intervention by third party authenticators for use, and in fact makes it possible, to be used in an entirely private manner without prejudging the possibility or the wish of the end user, to authorise direct or indirect access to an external network.

The following part describes the methods and processes used in the initialisation phase which makes it possible to move from non-personalised neutral equipment 30 coming from the manufacturer, to unique authenticated equipment 55 which is then operational at the place of the end user 60.

At the end of assembly the equipment is completely integrated and protected, the peripheral protection 10, 9 is activated. It is in a neutral initialisation state where the internal numbers are blank and an initialisation micro-code is pre-loaded in the random access memory 107 of the controller. An internal state logic machine 117 can assist the material protection of the non-alterable resources. The functional operating programme is the one which is loaded in the permanent or programmable memory in a unique manner 106 and is not alterable. The content of all the internal memories can be analysed and verified at any time. At the end of the initialisation, the initialisation programme is integrally deleted, the random access memory can no longer be used to run any programme and serves only for temporary storage of internal data. By way of suggestion, the initialisation programme is deleted gradually at each stage of the initialisation which ensures the uniqueness of the operations.

At power-up, the operating programme detects the initialisation state and runs the initialisation sequence or picks it up at the current stage.

The initialisation sequencing unfolds in three phases:
the personalisation phase, as represented in FIG. 5,
the authentication phase, as represented in FIG. 6,
the activation phase, as represented in FIG. 7.

As long as these three phases are not completed, the equipment is inoperative as storage peripheral, and no addressing, read or write operation on the internal peripheral is authorised.

The following description illustrates a sequencing suggestion.

The personalisation phase comprises the following operations starting from the neutral equipment 30:
31: Marking of the unique serial number externally 18 in the structure of the box for the equipment (external protection casing) in an indelible manner (by way of example marking by laser or mechanical engraving).
32: Input of the serial number in electronic form via the external interface.
33: Copy of the serial number 8 into the identification memory.
34: Input of the date and the reference time, relative to a calibrated and certified external reference time 16 (atomic clock and/or time server). The date and the time are programmed in universal time.
35: Synchronisation of the internal dating clock to less than a fraction of a second. By design, the time setting can only be effected once.
36: Random generation internally of the equipment of two passwords: these optional passwords make it possible to ensure minimum protection of the equipment and are single use: they allow protection of the equipment during storage or transit phases. The passwords are transmitted once only by the interface to the manufacturer 37 and 38 who transmits them independently to the entitled authenticating body and to the end user.
39: Self-generation of the secret identifier, internally of the equipment: a random generator calculates a long length identifier: in order to avoid any analysis, the encoding is over a number of bits such that the interrogation of the equipment for analysis of the secret identifier, is unimaginable by any screening or brute force methods, reducing the probability of finding this identifier by chance to an improbable value and this being the case even knowing the association between the provided third party elements (signatures) and the unique identifier. This identifier is stored in a volatile random access memory safeguarded by battery, destroyed instantaneously in the case of tampering.
40: Calculation of a one-way digital fingerprint, by a cutting algorithm (for example SHA1), relocating a one-way summary 23 of a few tens of octets (20 in the case of SHA1, standardised cutting algorithm FIPS 180-2) from a minimal message of some hundreds of octets (512 in the case of SHA1).
41: The equipment delivers the calculated digital fingerprint with the internal serial number for verification of uniqueness. To this end, a central 21, public database contains the totality of the serial numbers of the totality of produced equipment and used fingerprints. The interrogation makes it possible to know if-the identification is unique by means of an indirect method (fingerprint) which reveals no direct information about the secret internal identifier 7. Only the manufacturers can enter this information into the base which is public for consultation.
42: If the fingerprint is already being used, there is doubt about the uniqueness, a message is sent to the equipment in order that it submits a new identification.
43: If not, the database 21 is updated, and the initialisation process can continue.
44: All the manufacturer initialisation functions are then materially inhibited, for example by deletion (replacement by a zero instruction (NOP)) of the totality of the code situated in RAM which allowed this part of the initialisation to be effected, and possibly by inhibition of this memory space for subsequent running of programmes.
45: The equipment is, from now on, identified, and can be sent and/or made available to the authenticating body 22, alone entitled to know the association between the serial number and the unique identifier.

By way of example, a secret message of 4096 bits (512 octets) seems to give a quasi-total invulnerability to the system. At a rate of one interrogation per day, limited in occurrence by the equipment itself, approximately 12 years is necessary to recover 4096 different fingerprints which, despite everything, would not make it possible to return to the source, the normal fingerprints being ‘mathematically’ one-way and each having an enormous number of digital antecedents (>10¹⁰⁰), and an infinitesimal probability of clashing (<10⁻⁵⁰), sizes which constitute in themselves ‘physical infinities’.

The authentication phase then begins:

The entitled authentication body 22 receives in an independent manner the identified equipment 45 and the interrogation password 37.
46: Input of authenticating password 37.
47: Unique transmission of the unique secret identifier 7 over the operating interface.
48: Preservation of a copy of the unique secret identifier 17 by the entitled authenticating body, associated with the serial number 8.
49: Calculation of the fingerprint of the copy 17 according to the method used in the equipment 40.
50: Interrogation and updating of the state of authentication by request in the public identification database 21.
51: Confirmation of the association between the two fingerprints of the internal identifier and its copy.
54: In the case of failure of association, or impossibility of effecting the operation, the equipment is corrupted and must be rejected and dismantled 53, either because the equipment has already issued the unique identifier in an uncontrolled manner, or because it has crashed. The authenticating body then publishes the rejection of the numbered equipment in the public database 21.
55: In the case of success, the entitled body declares authentication of the equipment and publishes the latter in the public database 21.
52: The internal authenticating password is deleted and also the programmes and associated initialisation functions.

Only the entitled authenticating bodies can alter the state of authentication of equipment in the public database.

The entitled authenticating body guarantees the secrecy of the association between the public and secret identifiers, and can establish in the case of doubt and as a last resort the authenticity of the equipment. The entitled authenticating body and the manufacturer can be completely independent. There may be several manufacturers and several entitled authenticating bodies authorised by different authorities giving authentic value to the equipment. The entitled authenticating bodies can possibly share between them copies of the unique secret identifiers.

The equipment is then authenticated. It can be marketed and delivered to an end user who can make use of it after activation.

The end user who acquires the authenticated equipment 55 receives independently the initial password 38 issued by the manufacturer, and must activate it:
56: At the first power-up, he must connect the equipment and must enter the provided password.
57: The initialisation functions are then all invalidated: only the operating programme remains in place and can be run from this moment.
58: The equipment is functionally activated.
59: This state is indicated visually even without external supply (by way of example low ratio cyclic flashing of an LED type light supplied by battery).
60: Once the equipment is activated, the end user can use the equipment as a partitioned computer storage peripheral which is initially blank.

He can himself verify the authenticity and the validity of his equipment by the clarified methods.

This methodology guarantees however that no equipment can be diverted, removed or set up without checking and authentication.

The following part describes the methods which make it possible to establish the validity and authenticity of the equipment, made available to the end user and authorised authorities which are entitled to effect the checking of the equipment and recorded authenticated data.

The equipment and its unique identification being protected physically by the protection enclosure 10, the probability that a user can present equipment which is voluntarily corrupted and has an authentic appearance, is infinitesimal, however even this extreme case is catered for.

The failure of one of these methods indicates that the equipment is invalid, the success of a method being able to be elaborated by another method in the case of doubt persisting about the authenticity of the equipment.
Elementary methods not limited in occurrence:
61: Verification by comparison of the internal serial number 8 and the external serial number 18.
62: Verification of conformity of the equipment identified by its serial number 18 in the public database 21.
63: Verification of the progress of the internal clock 6.
64: Verification of the consistency of the internal clock 6 relative to an external reference 16, taking into account the specified drift of the internal clock.
65: Visual verification of integrity.
Third party methods involving the unique secret identifier 7 internally, made upon request and temporised internally in order to avoid any analysis of the identifier (for example, limited to one request per 24h):
67: Internal recalculation of the digital fingerprint 66 of the unique secret internal identifier 7 and verification with respect to the public database 2 1.
71: Internal calculation of the digital fingerprint of an external message 68 (for example a certificate) provided by an authorised body which is authorised to check the equipment, of a length at least equal to that of the unique identifier and mixed in a determinist but irreversible manner 70 with the unique secret internal identifier 7 and possibly the internal date 6 before calculation of the fingerprint of the overall result 66. The calculation elements 68, 6, the serial number 8 and the result are supplied to the entitled authenticating body 22 which keeps the copy of the secret identifier 17, which is therefore alone able to establish the consistency of the totality, and which confirms the authenticity to the applicant after verification.

The fact that the message 68 identifies the requesting body in a unique and self-consistent manner allows the authenticating body to limit the requests only to authorities which are authorised to effect the checks. The equipment for its part accepts a priori any message or request without prejudgement about the nature or the content of the message.
Direct method for checking the unique secret identifier:
72: Verification of the unique internal identifier directly by the entitled authenticating body. It is similar to the preceding method, except that the message which is provided is precisely the unique identifier 17. Exact correspondence is detected internally of the equipment 69 which provides as a response in a particular case a fingerprint which is calculated 66 uniquely on the basis of the unique identifier 7 and of the internal date 6.
Non-destructive assessment methods allowing a more detailed analysis using the following methods:
73: Dumping of internal memories (apart from secret identifier): ROM (Read Only Memory) 106, RAM (Random Access Memory) 107 or any other rewriteable memory (Flash).
74: Dumping of any manufacturer identification number from internal components accessible in electronic form. By way of example: models, inspections, unique serial numbers of the components used, binary code of the programmable components.

Destructive assessment methods demanding controlled dismantling of the equipment after, if possible, controlled copy of the data on another medium.
75: The equipment is arranged in order to allow simple mechanical cut-out in order to allow direct access to the native electrical interfaces 76 of the internal storage peripheral 1, and to other elements 77 for assessment. This destructive operation instantaneously invalidates the authenticity and any other functionality.

As a suggestion for implementation, all these methods can use virtual files managed directly by the controller, and appearing as files available on the peripheral, whilst they are not in fact directly stored on the integrated peripheral 1. These files can be accessed in read, and for certain ones in write in order to allow the end user to change the global parameters of the equipment which he controls, or to allow verification of the authenticity to third parties by inputting the parameters. This method can also be used for changes in data systems, identifiers or passwords during the initialisation phases (identification, authentication, activation).

As a suggestion for non-limiting implementation, the virtual files can contain:
78: the internal date 6, possibly associated with important dates, such as the date when the time was first set, and the authentication date,
79: the internal electronic serial number 8,
80: the authentication elements,
81: the system parameters, the writing making it possible to effect certain optional operating modes which are programmable by the user (by way of example, time zone, expiry, control and access limitation . . . ),
82: the state of the system,
83: the log file of exceptional events,
84: the elements monitored by the equipment, internal voltages, temperatures, in the case of a SMART hard disk (Self-Monitoring, Analysis and Reporting Technology),
85: the contents of the ROM memory,
86: the contents of the RAM memory,
87: the ‘manufacturer's’ identification elements.

It is recommended that all these files are easily readable by a human operator and are printable (use of an alpha-numeric code, for example base 64, with limitation of the number of characters per line or even HTML or XML standards).

The following example illustrates the operation of the virtual files: the authentication file 80 is encoded in order to be easily editable in a reserved system file named by way of example <AuthChek.sys>. Writing is possible if the anti-analysis temporisation conditions are fulfilled 88. Writing to this file triggers the internal calculation of one of the authentication elements, depending upon the nature of the written file:
empty file 89,
file containing a formatted input message 68,
file containing exactly the unique secret identifier 17.

In read, the system returns, at the end of calculation, a file of fixed length and structure comprising in association, according to the previously clarified methods, a formatted message which is ready to be sent for verification, and including all the necessary elements for verification: a fixed length fingerprint, the serial number, the message used, the date used.

As an option or variant, in the case where the application requires an afterglow of data which is much less than the subjective or objective lifespan of the equipment, an expiry option can make it possible to free from the place on the medium, by destroying if necessary automatically, the obsolete files in the past relative to the internal clock. The operability limits can be fixed either by constructional design or by the entitled authenticating body, or during initial start-up by the end user, and can comprise limitations on the freed space, such as for example necessarily protecting a fraction of the total capacity. The expiry is expressed typically in the number of days relative to the present, such as dated by the internal clock, and can be adjusted to calendar events (beginning or day of the week, beginning or day of the month, beginning or day of the year). Internal dating in universal time means that at least one day of margin is systematically added in order to take into account the time lag in local time and the drift of the internal clock.

The various modes of operation connected to the expiry are clarified in FIGS. 11 to 16. The storage space is represented in the form of a rectangle.

The storage space is initially empty 90.

The addition of new files 91 progressively fills the storage space. The previously written data are protected against alteration 4, the new file takes its place in the free space 5 and is dated at the end of writing to the current internal date 26, thus increasing the protected occupied space 4.

The files therefore sequentially fill the storage space in the course of time 92.

In the mode of operation without expiry, the storage space is filled completely: any attempt to write a file which exceeds in capacity the remaining free space is rejected and reports an error 93.

The mode of operation with expiry is clarified hereafter. The expiry term determines a pointer 94, on this side of which the data can be deleted uniquely if necessary. When the peripheral is full, a file with a size larger than the available free space can be added, by integrally deleting one or more files which have expired. The file which was not able to be written due to a lack of free space can then be stored by zapping the bare minimum of files which have expired, even if it means being split into two non-contiguous parts 95, 96. The files are deleted completely, thus leaving possibly a surplus free space 5, the size of the new written file not being necessarily exactly identical to the size of the old zapped files.

Other files can be added according to the same principle 97. The system protects the old files beyond the expiry term. If writing the new file involves destruction of a file not fulfilling the expiry terms, the peripheral is considered as ‘full’, the operation is annulled 98 and reports an error.

In the case where the expiry mechanism is implemented, the storage space has a circular structure 99 contrary to the standard linear structure 92 without expiry.

The peripheral reports a virtual free space corresponding to the space liberated potentially by zapping the totality of files which have ‘expired’.

The medium can advantageously be partitioned with a variable expiry duration. Once programmed, the expiry duration cannot be changed. Partitioning advantageously allows management on different logic units of different expiry durations. The partitioning can be fixed:
number of partitions fixed at activation by the user, then size of partitions fixed.

The partitioning can be dynamic:
number of partitions variable but limited (no data or active partition can be deleted in the totality of the partitions).

According to a particular embodiment connected to the current state of the art, available interfaces and the existence of current base components, FIG. 17 shows a more detailed synopsis of a suggestion for implementation based as a non-limiting example on a hard disk 100. Likewise, the described operational splitting does not necessarily reflect the structure of the components which are used, each function being able to be, in future implementations, distributed or integrated differently. By way of example, it is perfectly conceivable to integrate all or part of these functions in the internal electronic system integrated in the hard disk, which already comprises, in current implementations, a controller which is able to cover a part of the requested functions by alteration of the micro-code.

The controller as defined is based on an interface (bridge) component 101, normally integrating a processor which is able to run a programme interpreting the commands, and usually, two standard interface controllers for storing data 102, 103. In order to ensure optimal performance, these special controllers have specific material resources internally which are optimised in order not to impair the overall performance with respect to the transfer of data. By way of non-limiting example in view of the constant development of standards in this respect, there are intelligent converters for the external interfaces 105 of the FireWire/USB/Ethernet/SerialATA type to peripheral storage interfaces ATA, IDE, SerialATA 102. According to the standard used, a specific active physical interface can be integrated or entrusted to an external component 104 according to the transmission technology which is used.

This controller must be able to address a non-alterable internal or external programme memory in ROM (ROM or OTP One Time Programmable) 106, and a data memory in RAM (107) safeguarded by battery 108 without external supply thanks to a commutation device 109, or possibly based on a Flash type memory or on a combination of the two technologies.

The functional and operational micro-code, apart from the initialisation phase, is uniquely in ROM and can be neither altered nor updated. The initialisation micro-code is pre-loaded in the data memory 107 during manufacture and destroyed before activation in an irreversible manner.

No programme or micro-code can be loaded by the standard interfaces.

The operational data memory is safeguarded in order to keep the temporary or non-critical intermediate parameters of the state of the system, and/or the history of past operations (journal or ‘log’) or currently in the case of a break in external supply. The controller 101 does not need to be supplied autonomously.

An independent controller 110 can be associated with the controller 101, allowing monitoring of the internal state of the system with or without any external supply source, itself supplied also by battery 108. The monitoring controls the state of the equipment, the voltages of the internal batteries and possibly other significant physical parameters (temperature). It is capable of ordering an external indicator 111 (light/LED) to interface, giving visually the state of the system even without supply, and is able to warn of faults in the equipment or its invalidation. The state of validity of the equipment indicated by this means must be correlated by other methods of investigation during supply.

The controller 101 indirectly addresses a volatile memory component/real time clock 112, comprising a volatile memory which can be deleted by an external signal 119. These components natively manage a supply safeguarded by battery 113 connected to their permanent functionality. The real time clock is associated with an oscillator compensated in temperature with low consumption 114, itself also safeguarded by battery 115. It is the stability of this oscillator which determines the maximum drift of the clock. By way of example, there are compatible compensated oscillators with a battery supply which ensure a guaranteed drift less than 1 minute per year, which is reasonable and not particularly critical insofar as the drift can be measured at any moment.

The integrated deletable memory contains the unique identifiers: serial numbers 8 and unique secret identifier 7, as well as possibly other parameters judged to be critical (pointers . . . ).

The real time clock assembly 112, 114 is secured by a sequential logic 116 which can be integrated in a programmable logic component with low consumption supplied by battery 113. This logic manages the initialisation modes, the operational mode and the mode for destruction of unique parameters and integrates an operational machine 117 ensuring the unique irreversible sequencing of operations.

At initialisation, the sequencer 116 assists the described process and ensures sequential protection in write of the parameters before being initialised once and once only (clock, identifiers) into the component 112.

The initialisation sequence can be unfolded once, from an unstable state forced artificially during manufacture, the passage to the following state being ensured by the controller until the operational state, then possibly the invalidation state. Break in the safeguarded supply or detection of intrusion resets the operational machine in an initial state corresponding to the invalidation state of the equipment.

Functionally, the sequencer 116 ensures the temporised material protection in read of the unique secret identifier, by authorising its access in a limited temporised manner via the real time clock to, for example, once per 24 hours.

In the case of detection of intrusion or a supply fault, it ensures inhibition of the real time clock by blocking the oscillator 114 towards the latter, and re-ensures the invalidation of the identification parameters which are possibly not deleted. Access to the serial number and to the clock in read from the controller remains possible, the access in read to the unique deleted identifier is definitively inhibited for invalidation control and any write access.

The intrusion alert system 118 is connected to the intrusion sensor which is used and permanently checks the electrical parameters of the sensor (resistor 121, capacitor 122, short circuit or open circuit 123) and also the temperature 120. This part is entirely autonomous and self-supplied by battery 124. A state of alert, or the absence of supply by battery 124 deletes 119 the volatile memory containing the identifiers 112 and reinitialises the logic element 116 which moves into an invalidated equipment state.

The system is supplied for the operating part by external power supply 125, 14, possibly backed-up by cut-out converters or voltage regulators 126 which generate internal supply voltages for the equipment. The permanent supply saves on internal batteries thanks to an electronic switching system 127 which uses the external supply 125 as a priority, an optional external auxiliary battery 128, and finally as a last resort the internal batteries 108, 113, 115, 124 which makes it possible to extend the lifespan of the equipment, essentially limited by the lifespan of these internal batteries.

The number of internal batteries depends upon the consumption and operational independence of each sub-assembly. The distribution is given purely indicatively.

The battery of the intrusion detector is possibly doubled for redundancy, but remains independent of any other internal supply source.

The components 100 to 106 are supplied only by the main external source.

The external interfaces such as the supplies, the input/output buses, the control signals are protected from excess voltage, excess current and are filtered 129 in order to avoid that the system can be impaired by a defective source, or voluntarily by application of extreme levels which are able to put the equipment into an unknown state of vulnerability.

The RAM 106 used by the controller must at no time comprise a consistent partial copy of the secret internal identifier 7.

The totality of the internal elements is sunk in an electrically insulating and thermally conductive resin 130.

A non-secure second casing 131 protects the totality of the equipment against shocks in order to avoid any false accidental alarm, carries the wearing interfaces (mechanical, connection interfaces), the auxiliary interchangeable battery, the visual indicators (lights) and possibly sound indicators (buzzer), and makes it possible to improve the aesthetic and/or external ergonomic appearance. This double casing must leave visual access to the external serial number and must be easily removable in order to be able to effect control of the integrity of the equipment by itself. The double casing can be adapted for usage of the peripheral: removable peripheral or fixed in a standard 3½″ or 5¼″ drawer, external peripheral, peripheral integrated into a portable, individual or server computer.

The depressurisation capsule of the hard disk is carried by a conduit 132 to the outside of the enclosure 10 without impairing the vulnerability (connection piece and capillarity).

The following devices and methods are able to be implemented advantageously and are listed without being exhaustive:

An auxiliary serial interface 133 can allow independent limited access to the controller in the case of failure of the main input/output operating interface 105, in order to analyse the authenticity and validity of the equipment, or can be used for advanced access control or secure copy functions by interfacing, by way of example a smart card.

It is necessary to provide a certified method for transmission of data with preservation of the legal validity: authenticity and dating. By way of example, this can be implemented using an external cryptographic method of signature and of digital certification. An interface of the ‘smart card’ type can be used likewise in this case with a cryptographic card authenticating the transfer of data from the source equipment to target equipment using the internal date and the secret identifiers of each of the two.

According to a variant which is not necessarily implemented, in the typical case where the controller runs an on-board programme or contains programmable circuits, the object code (possibly source) can be published and in fact can be checked.

According to a variant which is not necessarily implemented, it seems useful to include an autonomous system for protecting access to the data by the user by password or any other identification method (smart card), in order to inhibit upon request:
access to data in write
access to data in read (return of empty contents, by way of example a ‘zero’ character chain)
the visibility of directories and file names
any access to the files

According to a variant which is not necessarily implemented, it is wise to include an internal system for limiting the filling quota which can avoid deliberate or accidental filling of the equipment (expressed by way of example in megaoctets per number of days) or can make it possible to anticipate the replacement of the equipment for extending the storage capacity.

According to a variant which is not necessarily implemented, it is possible, according to the file system which is used, to provide a possibility for changing the name of the files and directories, in order to facilitate use of the data in the past. This likewise provides the possibility of modifying the tree structure of the directories and any movement of logic data insofar as this has no influence on the contents, nor the date, nor possibly on extending or making versions of the files. Renaming of the files can be implemented, only the basic header cannot be altered: renaming the long name, without tampering with the short name (8.3 characters in numerous usage systems). The displacement of files can be implemented: directory changing, without tampering with data.

One means of protecting in read can advantageously be implemented by partition, ensuring the protection of the confidentiality of the data, the commutation of this function can be controlled by password or smart card, and by partition.

The described device is particularly adapted to private storage and archiving of computer data which are likely to have authentic, juridical and/or legal evidential value before authorised authorities.

1-16. (canceled)

17. Method for storing computer data, characterised in that it comprises integrating entirely in one device:
a data storage peripheral (1),
an adapted input-output controller (2) transforming said data storage peripheral (1) into a single- or restricted-write storage peripheral by diverting all input-output interface (13) commands from a host system (20) to the internal interface (3) of the integrated data storage peripheral (1), in order:
to authorise exclusively the addition of new files in the free space (5) by dating them independently thanks to a secure internal real time clock (6), and
to prohibit the deletion, alteration and rewriting of previously written and hence prior dated data (4),
to protect the totality of said device on the one hand against forgery or duplication by a unique secret internal identifier (7) by association with a unique public serial number (18), on the other hand by a peripheral protection enclosure (10) intended to prevent intrusion into the equipment, the alteration of any component and internal data, and also the analysis of the unique secret identifier without compromising the validity and authenticity in an irremediable manner,
to detect said intrusion, alteration and analysis attempt, said detections being able to be verified by several third party methods on said process, the latter being thus secure and suitable for storing authenticated, dated computer data with an evidential value,
and in that it comprises furthermore making it possible to guarantee the unique, unreproducible personalisation of the equipment whilst publishing its existence, possibly before authentication, by generating randomly by calculation internally of the equipment, said unique secret identifier (7), by calculating internally a one-way digital fingerprint (23) of the unique secret identifier (7) which does not allow return to the latter, by establishing the uniqueness of the fingerprint by interrogation of a public database (21) containing the fingerprints of the totality of existing equipment, the identifier being recalculated if there is a clash and the device being formally identified as soon as the fingerprint is unique, by adding therefore into the public database (21) the references of the equipment: unique serial number and fingerprint (23).

18. Method according claim 17, characterised in that it comprises reproducing electronically and internally (8) said unique public serial number in order to allow electronic control of the latter.

19. Method according to claim 17, characterised in that it comprises furthermore physically protecting all the internal components by leaving accessible only the external functional input-output (13) and supply (14) interfaces, thanks to a peripheral sealed enclosure (10) encompassing all the components, formed by a passive mechanical and electromagnetic protection (11) incorporating an active intrusion detection sensor (12) and the associated electronic system (9), the latter ensuring the immediate destruction of the unique secret internal identifier (7) and the internal serial number (8) if necessary, by instantaneous deletion, in the case of voluntary or involuntary deterioration changing the vulnerability or the autonomy of the device, or any internal investigation attempt detected by the sensor (12) being able to make it possible to compromise, control, alter, analyse data, interfaces or internal components.

20. Method according to claim 19, characterised in that it comprises furthermore keeping active the internal real time clock (6), the secret identifier (7), the internal serial number (8) if necessary and the electronic system for detection of intrusion and destruction (9), without any external supply source for the lifespan specified for the equipment, thanks to an autonomous internal supply sub-system (15), possibly backed-up externally in order to extend the lifespan thereof.

21. Method according to claim 17, characterised in that it comprises furthermore ensuring the authenticity of the device after manufacture, the test, the final assembly and the activation of the peripheral protection (9), until acquisition by the end user, by making unique the operations for assigning the unique serial number (8, 18), the synchronisation of the real time clock (6) relative to an external trusted time reference (16), internal self-generation of the unique secret identifier (7), the external copy of the unique secret identifier (17) in a secure environment of the unique secret identifier to an authenticating body (22) entitled to guarantee the secrecy of this identifier and in fact the authenticity of the equipment, the uniqueness of each operation being guaranteed by design by inhibiting or destroying, in an irreversible manner and as soon as possible in the initialisation sequence, the material elements and/or the micro-code allowing this initialisation.

22. Method according to claim 17, characterised in that it comprises furthermore allowing without limitation on the occurrence, the preliminary verification of the authenticity and of the integrity, by checking and cross-checking unique listed serial numbers (8, 18) in the public database (21), by checking the validity and the progress of the internal clock (6) relative to an external trusted time reference (16), taking into account the maximum specified drift of the internal clock, and by visual or non-destructive checking of the integrity of the external casing (12).

23. Method according to claim 21, characterised in that it comprises furthermore allowing authorised bodies to authenticate the equipment upon request by verification via third party methods using the secret internal identifier (7) without revealing it, by internally recalculating dynamically the fingerprint of the identifier (23) and by directly interrogating the public database (21), or by internally connecting the secret identifier to the internal date (6) and to an external message provided before internal calculation of the fingerprint of the totality, the totality of known elements being provided for authentication remotely by the entitled authenticating body (22) which alone can verify the consistency thanks to the copy of the unique secret identifier (17) which it has, these functions involving the secret identifier being temporised and limited in occurrence internally of the equipment in order to avoid inverse determination of the identifier by analysis or successive attempts.

24. Method according to claim 21, characterised in that it comprises furthermore allowing the authenticating body (22) itself to authenticate the equipment under its control and as a last resort by injecting its copy of the secret identifier (17) for comparison internally of the equipment which detects perfect similarity, and sends in reply a unique message which can be verified by said authenticating body (22), this function involving the secret identifier being temporised and limited in occurrence internally of the equipment in order to avoid inverse determination of the identifier by analysis or successive attempts.

25. Method according to claim 17, characterised in that it comprises furthermore allowing, by way of variant which is not necessarily implemented, managing autonomously the expiry of data in the past, by authorising, solely in the case of complete filling of the internal storage peripheral (1), writing of new files by zapping, within sufficient limits and in chronological order, data prior to a relative date (94), updated dynamically relative to the current date provided by the internal clock (6), departing thus from the single-write rule without however compromising or altering the useful data which are still valid and dated subsequently to the expiry date.

26. Method according to claim 17, characterised in that it comprises furthermore presenting any internal parameter and indicator which is characteristic of and specific to said device in the form of virtual files in reserved names, seen by the host system as standard files and avoiding using drivers or particular operating modes at the level of the host system for management, administration and monitoring of said device.

27. Method according to claim 17, characterised in that it comprises furthermore partitioning said data storage peripheral with a different expiry duration by partitioning.

28. Device for storing computer data, characterised in that it integrates in full:
a data storage peripheral (1) comprising an internal interface (3),
an adapted input-output controller (2),
an input-output interface (13),
a secure internal real time clock (6),
a unique secret internal identifier (7),
a unique public serial number,
a peripheral protection enclosure (10),
said adapted input-output controller (2) being able to transform said data storage peripheral (1) into a single- or restricted-write storage peripheral by diverting all input-output interface commands (13) from a host system (20) to the internal interface (3) of the integrated peripheral (1), in order:
to authorise exclusively the addition of new files in the free space (5) by dating them independently thanks to the secure internal real time clock (6), and
to prohibit the deletion, alteration and rewriting of previously written and hence prior dated data (4),
means for guaranteeing the unique, unreproducible personalisation of the equipment whilst publishing its existence, possibly before authentication, by generating randomly by calculation internally of the equipment, said unique secret identifier (7), by calculating internally a one-way digital fingerprint (23) of the unique secret identifier (7) which does not allow return to the latter, by establishing the uniqueness of the fingerprint by interrogation of a public database (21) containing the fingerprints of the totality of existing equipment, the identifier being recalculated if there is a clash and the device being formally identified as soon as the fingerprint is unique, by adding therefore into the public database (21) the references of the equipment: unique serial number and fingerprint (23),
the totality of said device being protected on the one hand against forgery or duplication by the unique secret internal identifier (7) by association with the unique public serial number, on the other hand by the peripheral protection enclosure (10) preventing intrusion into the equipment, the alteration of any component and internal data, and also the analysis of the unique secret identifier without compromising the validity and authenticity in an irremediable manner, intrusion, alteration and analysis attempts being able to be verified by several third party means on the totality of said device, the latter being thus secure, inviolable and forgery-proof, suitable for storing authenticated, dated computer data with an evidential value.

29. Device according to claim 28, characterised in that it comprises a serial number reproduced electronically and internally (8) reproducing said unique public serial number.

30. Device according to claim 28, characterised in that it comprises means for physically protecting all the internal components by leaving accessible only the external functional input-output (13) and supply (14) interfaces, thanks to a peripheral sealed enclosure (10) encompassing all the components, formed by a passive mechanical and electromagnetic protection (11) incorporating an active intrusion detection sensor (12) and the associated electronic system (9), the latter ensuring the immediate destruction of the unique secret internal identifier (7) and the internal serial number (8) if necessary, by instantaneous deletion, in the case of voluntary or involuntary impairment changing the vulnerability or the autonomy of the device, or any internal investigation attempt detected by the sensor (12) being able to make it possible to compromise, control, alter, analyse data, interfaces or internal components.

31. Device according to claim 29, characterised in that it comprises means for keeping active the internal real time clock (6), the secret identifier (7), the internal serial number (8) if necessary and the electronic system for detection of intrusion and destruction (9), without any external supply source for the lifespan specified for the equipment, thanks to an autonomous internal supply sub-system (15), possibly backed-up externally in order to extend the lifespan thereof.
